(19) United States
(12) Patent Application Publication
(10) Pub. No.: US 2010/0116857 A1
(43) Pub. Date: May 13, 2010

(54) ANIMAL LEAD HANDLE DEVICE

(76) Inventor: Frank Vickers, Lower Hutt (NZ)

Correspondence Address: BROOKS KUSHMAN P.C., 1000 TOWN CENTER, TWENTY-SECOND FLOOR, SOUTHFIELD, MI, 48075, US

(21) Appl. No.: 12/594,328

(22) PCT Filed: Mar. 17, 2008
(86) PCT No.: PCT/NZ08/00060

§ 371 Date: Oct. 1, 2009

(30) Foreign Application Priority Data
Apr. 13, 2007 (NZ) 554510

(51) Int. Cl. A45F 5/00; A01K 27/00

(52) U.S. Cl. 224/191; 119/795

(57) ABSTRACT

An animal lead handle device having a handle with a hand grip portion connected to a lead attachment portion. The hand grip portion has a first compartment to accommodate a sanitiser dispensing means and the lead attachment portion has a lead attachment means and a second compartment to accommodate a roll of plastics bags. The plastic bags are dispensed individually one at a time from the second compartment and the sanitiser dispensing means situated in the first compartment allows sanitiser to be dispensed to sanitise a user hands.

The invention relates to an animal lead handle device, typically for use with dogs.

### BACKGROUND OF INVENTION

When taking an animal, such as dog, for a walk it is the owners responsibility for the dog owner to pick up any droppings/excrement deposited by the animal. It is known to use pooper scooper devices, plastic bags or other such means to pick up the animals droppings/excrement. Some of these have been moderately successful, however they are either cumbersome or separate items to which the owner can either deliberately or unintentionally not take with them. There have been devices that can be attached to leads or to handles of leads, but again these are either cumbersome to use and/or rely on the user to attach theses devices to lead and/or handle.

Also another problem surrounds the hygienic aspect of picking and/or handling animal droppings/excrement. Sanitisers are known, however these are separate items, that if remembered to be taken, are usually kept in the pocket of the owner and as such are usually overlooked once finished tending to the animal droppings/excrement.

### OBJECT OF THE INVENTION

It is an object of the invention to provide an animal lead handle device, typically for use with dogs, that ameliorates some of the disadvantages and limitations of the known art or at least provide the public with a useful choice.

### SUMMARY OF INVENTION

In a first aspect the invention resides in an animal lead handle device, typically for use with dogs, having handle with a hand grip portion connected to a lead attachment portion, wherein the hand grip portion has a first compartment dimensioned and adapted to accommodate a sanitiser dispensing means and the lead attachment portion has a lead attachment means and a second compartment dimensioned and adapted to accommodate a roll of plastics bags, wherein in use plastic bags are adapted to be dispensed individually, one at a time from the second compartment to pick animal excrement and the sanitiser dispensing means situated in the first compartment is adapted to allow sanitiser to be dispensed to sanitise a user hands after picking up the animal excrement.

Preferably, the compartments extend and lie in the same plane as one another.

Preferably, the compartments are spaced a distance from one another.

Preferably, each compartment has a first opening that is dimensioned and adapted to allow the sanitiser dispensing means and roll of plastic bag can be inserted into the respective compartment.

Preferably, there is an opening situated between the hand grip portion and the lead attachment portion such that the opening is dimensioned and adapted to allow the fingers of a users hand into the opening so as to assist in the gripping of the hand grip portion.

Preferably, the circumference of the opening on hand grip portion side of the opening is undulated such that the undulations are adapted to correspond to the fingers of a users in order to provide an ergonomic and comfort gripping of the hand grip portion.

Preferably, the second compartment has a bag dispensing opening positioned and situated at an end opposite of the first opening in which the roll of plastic bags is inserted, wherein the bag dispensing opening is of a size suitable to allow only a plastic bag to be pulled there through one at a time from the roll of plastic bags and subsequently detached therefrom.

Preferably, the lead attachment means is an aperture situated in a forward position on the lead attachment portion relative to the hand grip portion, wherein the aperture is adapted to allow an fastening means on a lead to be releasably attached to the lead attachment portion.

Preferably, the fastening means is a slip ring, clip, clasp, latch or other suitable means capable of being fasten to a dog lead and inserted and/or attached through the aperture on the lead attachment portion.

Preferably, the lead attachment portion has a bag attachment means upon which a used plastic bag can be releasably attached thereto.

Preferably, the bag attachment means is positioned and situated proximate the lead attachment means.

Preferably, the handle has closure means adapted to at least close the first opening of the second compartment in order to releasably retain the roll of plastic within the second compartment.

Preferably, the closure means is rotatably attached to the handle about a pivot or hinge.

Preferably, the closure means is adapted to retain the sanitiser dispensing means in the first compartment.

Preferably, the closure means retains the sanitiser dispensing means in the first compartment by a distal end of the closure means pressing and holding the sanitiser dispensing means in place when the closure is a closed position.

Preferably, the closure means is held in a closed position by a snap fit action with respect to the body of the handle.

Preferably, the closure means is held in a closed position respect to the body of the handle by suitable known fastening means, such clasping means, hook loop fasteners, latching means, snap fit or the like.

Preferably, the handle is D shaped, wherein the first compartment is housed longitudinally in the straight part of the D and the second compartment is housed longitudinally in the curved part of the D.

Preferably, the handle and/or the closure includes an LED light with on/off flashing mode, a small voice recorder capable of recording and reproducing a dogs owners call/command whistle, a reward clicker and/or an alarm signal.

In a second aspect the invention resides in a method using an animal lead handle having a having handle with a hand grip portion connected to a lead attachment portion, wherein the hand grip portion has a first compartment dimensioned and adapted to accommodate a sanitiser dispensing means and the lead attachment portion has a lead attachment means and a second compartment dimensioned and adapted to accommodate a roll of plastics bags; wherein the method includes releasing inserting the roll of plastic bags into the second compartment therein such that a portion of one plastic bag extends outward through an opening in the second compartment and placing the sanitiser dispensing means in the first compartment 11, attaching an animal lead to the handle and to an animal, then when the animal has passed their bowels a plastic bag is pulled from the second compartment and the excrement picked up and tied off in the usual manner, attaching the used bag to the handle, activating the sanitiser dispensing means in order sanitise the users hands.

A third aspect of the invention resides in an excrement pickup and sanitary animal lead handle device typically for use with dogs, having handle with a hand grip portion connected to a lead attachment portion, wherein the hand grip portion has a first compartment dimensioned and adapted to accommodate a sanitiser dispensing means and the lead attachment portion has a lead attachment means and a second compartment dimensioned and adapted to accommodate a roll of plastics bags, wherein in use plastic bags are adapted to be dispensed individually, one at a time from the second compartment to pick animal excrement and the sanitiser dispensing means situated in the first compartment is adapted to allow sanitiser to be dispensed to sanitise a user hands after picking up the animal excrement.

In other aspects herein described

### BRIEF DESCRIPTION

The invention will now be described, by way of example only, by reference to the accompanying drawings:

FIG. 1 is a cut-away side view of the animal lead handle device in accordance with a first preferred embodiment of the invention.

FIG. 2 is a cross-sectional top view of the animal lead handle device as shown in FIG. 1.

FIG. 3 is a side view of the animal lead handle device in an open state in accordance with a first preferred embodiment of the invention.

### DESCRIPTION OF DRAWINGS

The following description will describe the invention in relation to preferred embodiments of the invention, namely an animal lead handle device. The invention is in no way limited to these preferred embodiments as they are purely to exemplify the invention only and that possible variations and modifications would be readily apparent without departing from the scope of the invention.

FIG. 1 shows a cut-way side view of the animal lead handle device 1 including a handle portion 14 having-two compartments 11 & 13 and a hand gripping aperture 13. The first 11 of the two compartments is dimensioned to accommodate a sanitiser/desordiser 20 and the second compartment 12 is dimensioned a roll 21 of detachable plastic bags, preferably plastics bags suitable for picking up animal excrement. The second compartment 12 has a closable opening 23 at one end and an aperture 15 at the opposite end that is adapted to allow plastic bags held in the compartment 12 to be dispensed via aperture 15 one at a time, preferably by pulling bag portion 22 through the aperture 15.

The handle portion is preferably D shaped and one compartment is housed longitudinally in the straight part of the D and the other compartment is housed longitudinally in the curved part of the D.

The handle portion has a used bag holding portion 16, preferably a hook, such that a used plastic bag can be suspended until such time it can be disposed in a rubbish bin or the like. Also the handle portion 14 has an aperture 17 for accommodating and attaching a ring 30 from which a lead/leash 31 can be attached such that an animal is able to be controlled and lead in the usual manner.

FIG. 2 is a cross-sectional top view of the device shown in FIG. 1 that clearly shows the position of the compartments relative to one another. In the preferred use position the sanitiser/deodorising compartment 11 is spaced from the plastic bag compartment 12 and distal from the leash attachment aperture.

FIG. 3 shows the invention having a closure 17, in an open position, to allow access to and/or insert plastic bags in the compartment 12 (see FIG. 1). The closure 17 is pivotally mounted to the handle portion 14 via pivot pin 19, or other type hinge type arrangement, such that in a closed state the closure 17 fully closes the compartment opening 23 in order to retain the roll of plastic bags 21 in compartment 12.

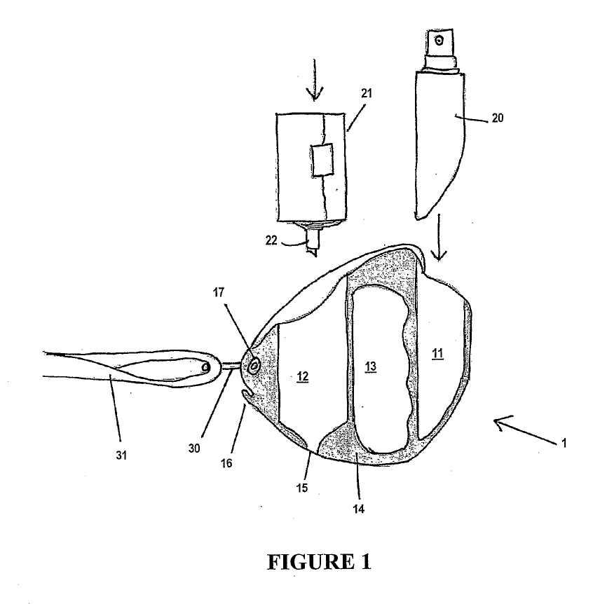

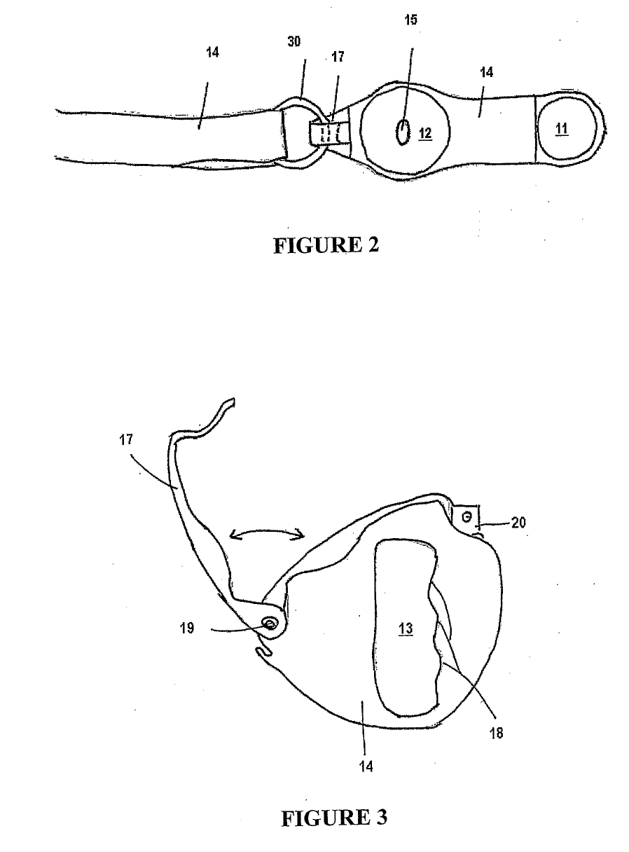

The handle portion 14 along an edge surrounding the hand gripping aperture 13 is undulated 18 and dimensioned to accommodate the fingers of user to assist in the ergonomic comfort and holding of the animal lead handle device.

The animal lead handle device will now be described in use as a dog lead handle device. The handle 1 is designed to be attached to a standard dogs lead 31 via ring 30 and lead attachment point aperture 17. The handle has two compartments 11 & 12, one 11 incorporated into the handle grip, containing a spray sanitiser, and the other compartment 12, located between the lead attachment point, housing plastic bags. Compartment 12 has the ability via aperture 15 to access one bag at a time from within the compartment 12. The handle has a used bag attachment 16 situated in a forward underside position of the handle from which used bags are able to attached. A closure 17 releasably retains the bags within the compartment 12. There is space on the handle and the closure for mounting an LED light with on/off flashing mode and a small voice recorder capable of recording and reproducing a dogs owners call/command whistle or reward clicker as well as an alarm signal.

In use the dog owner releases the closure 17 in order to open and allow access to compartment 12 to load a roll of bags therein such that a portion of one plastic bag extends outward through the aperture 15. The sanitiser is placed in compartment 11. The handle device is attached to a lead and subsequently-once the lead is attached to a dog, the dog is able to be taken for a walk. When a dog has passed their bowels the excrement is able to picked up the owner using a plastic bag from the handle device. The owner dispenses such a bag by pulling a bag from the aperture 15 and once a complete bag has passed through the aperture 15 and a portion of the next bag as well, the complete bag is separated from the roll of plastic bags. The separated plastic bag is then used to pick up the excrement left by the dog and tied off in the usual manner. The used bag is then suspended on attachment 16 and disposed of later. Once the excrement has been picked up and bag suspended on attachment 16, the owner then can use the sanitiser 20 to sanitise their hands. The sanitiser 20 is situated in compartment 11 such that it is does not need to be taken from compartment 11 in order to be used, the user can activate the spray action of the sanitiser 20 whilst it is within compartment 11.

The animal lead handle devices allows for comfortable control of an animal on the lead, allows for easy clean up and carrying of animal droppings and ability to sanitise the hands of a user after picking up the animal droppings.

Variations

Throughout the description of this specification, the word “comprise” and variations of that word such as “comprising” and “comprises”, are not intended to exclude other additives, components, integers or steps.

It will of course be realised that while the foregoing has been given by way of illustrative example of this invention, all such and other modifications and variations thereto as would be apparent to persons skilled in the art are deemed to fall within the broad scope and ambit of this invention as claimed in the appended claims.

1. An animal lead handle device, having a handle with:
i. an elongate upright hand grip portion with a longitudinally extending compartment therein and a first top opening at the top end of the hand grip portion adapted to allow a sanitiser dispensing means to be accommodated and partially retained in said compartment such that the dispensing portion of the dispensing means protrudes outwardly from the first compartment;
ii. an elongate upright lead attachment portion connected to and spaced forwardly from the elongate upright hand grip portion, the lead attachment portion has a lead attachment means fixed thereto and a second longitudinally extending compartment that is spaced apart and substantially in parallel alignment with the first compartment, the second compartment has a second top opening in its top end adapted to allow a roll of plastics bags to be accommodated in the second compartment and the bottom end of the second compartment has a bottom opening adapted to allow plastic bags to be dispensed individually one at a time from the second compartment;
iii. a closure means pivotally fixed at one end to the lead attachment portion is adapted to pivot between a closed position and an open position such that when the closure means is in the closed position the closure means closes the second top opening of the second compartment and retains the sanitiser dispensing means within the first compartment but still allows access to the sanitiser dispensing means so that sanitiser is able to be dispensed from the sanitiser dispensing means and when in the open position the closure means is adapted to allow access to each of the first and second compartments; and
iv. a used bag holding means upon which a used plastic bag can be realeasbly attached;
wherein the animal lead is such that a user is able to extract a single plastic bag from the second compartment to pick up animal excrement, attach the used bag to bag holding means and sanitise the users hands after picking up the animal excrement by dispensing sanitiser from the sanitiser dispensing means without having to remove the dispenser from the first compartment and whilst maintaining control of the animal lead handle device during the bag extraction and sanitising operations.

2. The animal lead handle device as claimed in claim 1, wherein the animal lead handle device is an excrement pickup and sanitary animal lead handle device.

3. The animal lead handle device as claimed in claim 1 wherein the compartments extend and lie in the same plane as one another.

4. The animal lead handle device as claimed in claim 1 wherein the handle is substantially D-shaped such that the first compartment is housed within the upright straight part of the D and the second housing is housed within the portion of curved part of the D that is spaced and substantially in parallel alignment with the upright straight part of the D.

5. The animal lead handle device as claimed in claim 1 wherein there is a handle opening situated between said hand grip portion and said lead attachment portion such that the handle opening is dimensioned and adapted to allow the fingers of a users hand into the opening so as to assist in the gripping of said hand grip portion.

6. The animal lead handle device as claimed in claim 5 wherein the side of said hand grip portion facing the handle opening is undulated such that the undulations are adapted to correspond to the fingers of a users in order to provide an ergonomic and comfort gripping of said hand grip portion.

7. The animal lead handle device as claimed in claim 1 wherein the lead attachment means is situated in a forward position on said lead attachment portion relative to said hand grip portion, wherein the lead attachment means has an aperture adapted to allow a fastening means on a lead to be releasably attached to said lead attachment portion.

8. The animal lead handle device as claimed in claim 7 wherein the fastening means is a slip ring, clip, clasp, latch or other suitable means capable of being fasten to a dog lead and inserted and/or attached through the aperture in the lead attachment means.

9. The animal lead handle device as claimed in claim 1 wherein the holding means is a hook positioned on the underside of said lead attachment portion upon which a used plastic bag can be releasably attached thereto.

10. The animal lead handle device as claimed in claim 9 wherein the bag holding means is positioned and situated proximate the lead attachment means.

11. The animal lead handle device as claimed in claim 1 wherein the closure means is elongate member sized and dimensioned to extend across both compartment top openings when in the closed position.

12. The animal lead handle device as claimed in claim 11 wherein one end of the elongate member of the closure means is rotatably attached about a pivot or hinge to a forward portion of said lead attachment portion above, adjacent and proximate to the lead attachment means.

13. The animal lead handle device as claimed in claim 12 wherein the other end of the elongate member that is distal to the end attached to said lead attachment portion retains the sanitiser dispensing means in the first compartment by the distal end pressing and holding the sanitiser dispensing means in place when the closure is in a closed position whilst still allowing sanitiser to be dispensed from the sanitiser dispensing means.

14. The animal lead handle device as claimed in claim 13 wherein the closure means is held in a closed position by a snap fit action with respect to the handle.

15. The animal lead handle device as claimed in claim 13 wherein the closure means is held in a closed position respect to the handle by suitable known fastening means, such clasping means, hook loop fasteners, latching means, snap fit or the like.

16. The animal lead handle device as claimed in claim 1 wherein the handle and/or the closure means includes an LED light with on/off flashing mode, a small voice recorder capable of recording and reproducing a dogs owners call/command whistle, a reward clicker and/or an alarm signal.

17. A method using an animal lead handle as claimed in claim 1, wherein the method includes:
i. opening the closure means,
ii. inserting the roll of plastic bags into the second compartment therein via the second top opening and pulling a portion of one plastic bag through the bottom opening such that a portion of one plastic bag extends outward through the bottom opening in the second compartment,
iii. placing the sanitiser dispensing means in the first compartment via the first top opening so that the dispensing portion of the dispensing means protrudes outwardly from the first compartment,
iv. closing the closure means such that the closure means fully closes the top opening of the second compartment to retain the roll of plastic bags therein and the closure means retains the sanitiser dispensing means within the first compartment whilst still allowing sanitiser to be dispensed from the sanitiser dispensing means,
v. attaching an animal lead to the handle and to an animal,
vi. then when the animal has passed their bowels a plastic bag is pulled from the second compartment and torn from the roll of plastic bags leaving a portion of the next plastic to used extending out of the bottom opening,
vii. using the extracted plastic bag to pick up the excrement, tying the bag off in the usual manner,
viii. attaching the used bag to the handle, and
ix. then activating the sanitiser dispensing means in order sanitise the users hands.

18.-20. (canceled)
